(19) United States
(12) Patent Application Publication
(10) Pub. No.: US 2026/0337065 A1
(43) Pub. Date: Oct. 29, 2026

(54) PREPARATION OF PHOSPHORUS-DOPED HIGH-CURVATURE REGULATED TITANIUM SUBOXIDE POROUS ELECTRODES AND APPLICATION THEREOF IN ELECTROCHEMICALLY ENHANCED DEEP REDUCTION OF ANTIBIOTIC RESISTANCE GENES IN PHARMACEUTICAL WASTEWATER

(71) Applicant: North China Electric Power University, Beijing (CN)

(72) Inventors: Mingchuan YU, Beijing (CN); Junfeng NIU, Beijing (CN); Yufei ZHOU, Beijing (CN); Tousheng HUANG, Beijing (CN); Cong YAN, Beijing (CN)

(21) Appl. No.: 19/698,014

(22) Filed: Jun. 4, 2026

(30) Foreign Application Priority Data
Jun. 17, 2025 (CN) 202510803670.5

(51) Int. Cl. C02F 1/467; C02F 1/461; C02F 101/34; C02F 101/38; C02F 103/34

(52) U.S. Cl. CPC C02F 1/4672; C02F 1/46109; C02F 2001/46133; C02F 2001/46161; C02F 2101/34; C02F 2101/38; C02F 2101/40; C02F 2103/343; C02F 2303/04

(57) ABSTRACT

The present invention belongs to the technical field of environmental engineering, and provides a preparation of phosphorus-doped high-curvature regulated titanium suboxide porous electrodes and an application thereof in electrochemically enhanced deep reduction of antibiotic resistance genes in pharmaceutical wastewater. A high-curvature tip nanotube structure is fabricated by NH₄F electrochemical etching. The increased electrochemical active surface area and enhanced tip electric field effect thereof synergistically promote charge enrichment and electron accumulation, significantly increasing the average current density of a system. The surface curvature of titanium suboxide is further optimized by P-doping, and lattice expansion is induced by regulating the tensile strain of lattices, thereby reducing the overlap of Ti orbitals to narrow the d-band and migrate the energy level thereof upwards. The present invention has the advantages of simple electrode preparation process and cheap and readily available raw materials, and has a potential for large-scale production.

### TECHNICAL FIELD

The present invention belongs to the technical field of environmental engineering, and relates to a preparation of phosphorus-doped high-curvature regulated titanium suboxide porous electrodes and an application thereof in electrochemically enhanced deep reduction of antibiotic resistance genes in pharmaceutical wastewater.

### BACKGROUND

Antibiotics are new pollutants in water environments. With the wide use thereof, antibiotic-resistant microorganisms in natural water bodies have been frequently detected. The unrestrained use of such new pollutants has posed a major threat to environmental safety and human health. Antibiotic resistance genes (ARGs) are frequently detected in groundwater around the world, especially in areas near hospitals, livestock farms, aquaculture farms and landfill sites. Traditional ARG treatment methods include chlorination, ultraviolet (UV) radiation and ozone oxidation methods. However, due to the limited efficiency in inactivating highly drug-resistant aquatic bacteria, the traditional techniques usually require a large amount of disinfectant addition, which may lead to the accumulation of carcinogenic disinfection by-products. Compared with traditional treatment methods, electrochemical oxidation is regarded as an efficient and safe water disinfection technique due to the simple operation, mild conditions, no need of adding chemical reagents, and the ability of inactivating bacteria by generating various oxidants (such as H₂O₂, O₃, and highly active free radicals such as ⋅OH and O₂⋅⁻). The free radicals of hydroxyl radicals (⋅OH) have extremely strong oxidizability. Under the action of a current, the ⋅OH adsorbed on the surface of an electrode has a high reactivity to carbohydrate or polyphosphate skeletons of ARGs, which can lead to the inactivation of most ARGs. However, flat electrodes have the problems such as low electron utilization rate, low current density limitation, and difficulty in simultaneously removing antibiotics and ARGs in a process of removing ARGs by electrochemical oxidation, which leads to low degradation and inactivation efficiency and high energy consumption. Therefore, strategies need to be adopted to increase the current density of the electrode. However, at present, the current density of the flat electrodes during operation is generally low. Titanium suboxide has high oxygen evolution potential, excellent electrical conductivity and high corrosion resistance, and exhibits high efficiency in the inactivation of pathogens and the oxidation of various refractory compounds, which has been widely applied in the removal of ARGs and organic pollutants. However, flat titanium suboxide exhibits a relatively low interfacial charge transfer rate, which fails to provide sufficient current density. At the same time, the mass transfer efficiency in the reaction system is low. Therefore, ARGs cannot be effectively removed by electrocatalysis alone. Based on the above problems, in the articles “Simultaneous removal of antibiotic resistant bacteria and antibiotic resistance genes by molybdenum carbide assisted electrochemical disinfection” and “Enhanced removal of antibiotic-resistant bacteria and resistance genes by three-dimensional electrochemical process using MgFe2O4-loaded biochar as both particle electrode and catalyst for peroxymonosulfate activation”, a molybdenum carbide (Mo₂C)-electrode-assisted electrochemical disinfection process and a three-dimensional electrochemical process using MgFe₂O₄-loaded biochar (MFBC) as both a particle electrode and a catalyst for peroxymonosulfate activation are respectively adopted to enhance the removal of ARGs. Although the above research can increase the specific surface area and mass transfer performance of the electrode to a certain extent, the cost is increased by the additional addition of oxidants. In addition, the above modified materials still have considerable room for improvement in the aspects such as regulating the generation of active species (⋅OH) at active sites.

Based on this, the present invention selects porous titanium suboxide fibrofelt as an anode substrate material and uses an ammonium fluoride electrolytic solution to conduct electrochemical etching to prepare a high-curvature tip nanocone structure. The structure effectively increases the electrochemically active surface area, and the tip electric field enhancement effect thereof triggers the formation of a strong electric field distribution and charge enrichment in a high-curvature region, promoting the accumulation of a large number of electrons in electrochemical reaction and significantly increasing the average current density of the system. At the same time, through phosphorus doping, the surface curvature of titanium suboxide is further enhanced, and the tensile strain of lattices is precisely regulated: the overlap of titanium atom orbitals can be reduced by strain-induced lattice expansion, leading to the narrowing of the d-band energy level and the migration towards a higher energy level. The proportion of Ti³⁺ as an active site for ⋅OH generation and the concentration of oxygen vacancies are significantly increased after phosphorus doping, which promotes the stable and continuous generation of ⋅OH. At the same time, local electron configuration can be regulated by the introduction of a P site. Combined with the tensile effect of lattice strain, the adsorption and catalytic effect thereof on oxygen molecules can be enhanced, the energy barrier for singlet oxygen (¹O₂) conversion can be reduced, and the generation rate can be increased. ⋅OH has a strong oxidizing capacity and can react efficiently with refractory organic pollutants such as antibiotics, but the lifespan of ⋅OH is relatively short, so it is difficult to fully remove large-sized antibiotic resistance genes in water through ⋅OH. The empty orbital property of ¹O₂ endows ¹O₂ with strong electrophilicity, enabling ¹O₂ to react with unsaturated bonds in antibiotic resistance genes and disrupt the stability thereof. In addition, singlet oxygen has a long lifespan and a wide pH adaptability range. Compared with ⋅OH, singlet oxygen is more resistant to the interference of background ions and shows high selectivity for specific pollutants. Therefore, by combining the reaction characteristics of the two reactive oxygen species, ⋅OH and ¹O₂, with antibiotic resistance genes, efficient and low-consumption electrocatalytic degradation of antibiotic resistance genes and antibiotics in pharmaceutical wastewater can be effectively achieved.

### SUMMARY

The present invention provides a preparation method for phosphorus-doped high-curvature regulated titanium suboxide porous electrodes, and is applied to the electrochemical degradation of antibiotic resistance genes and antibiotics in pharmaceutical wastewater. A high-curvature tip nanotube structure is fabricated by NH₄F electrochemical etching. The increased electrochemical active surface area and enhanced tip electric field effect thereof synergistically promote charge enrichment and electron accumulation, significantly increasing the average current density of a system. The surface curvature of titanium suboxide is further optimized by P-doping, and lattice expansion is induced by regulating the tensile strain of lattices, thereby reducing the overlap of Ti orbitals to narrow the d-band and migrate the energy level thereof upwards. After doping, the proportion of Ti³⁺ and oxygen vacancies in the material are significantly increased, which enhances the ⋅OH generation capacity and increases the ¹O₂ generation rate. By combining the characteristics of the two reactive oxygen species, efficient and low-consumption electrocatalytic degradation of antibiotic resistance genes and antibiotics in pharmaceutical wastewater is ultimately achieved.

The technical solution of the present invention is as follows:

A preparation method for phosphorus-doped high-curvature regulated titanium suboxide porous electrodes comprises the following steps:
Step 1: immersing a piece of titanium suboxide fibrofelt in a sodium hydroxide solution with a concentration of 5-10 wt. %, and conducting treatment at a constant temperature of 70-85 °C for 0.5-1 hour; taking out the titanium suboxide fibrofelt, and conducting ultrasonic cleaning with deionized water to remove residual alkaline solution on the surface; subsequently, transferring the treated titanium suboxide fibrofelt to an oxalic acid solution of 10-15 wt. %, and continuing to conduct treatment at a constant temperature of 70-85 °C for 1-3 hours; and taking out the titanium suboxide fibrofelt, and thoroughly removing acidic residue on the surface with deionized water to obtain the treated titanium suboxide fibrofelt;
Step 2: uniformly mixing a 0.1 g/mL ammonium fluoride solution with ethylene glycol to prepare an electrolytic solution, in which the volume ratio of the 0.1 g/mL ammonium fluoride solution to the ethylene glycol is 1:20 to 1:10; using the treated titanium suboxide fibrofelt obtained in step 1 as a working anode and using two titanium mesh electrodes as dual cathodes to construct a dual-cathode and single-anode electrochemical etching system; conducting electrochemical etching for 3-6 hours under a voltage of 20-30 V and a current of 2-3 A, and after etching, thoroughly rinsing the surface with deionized water and blowing dry the moisture on the surface; transferring the treated working anode to a muffle furnace, raising the temperature to 300-500 °C according to a programmed temperature ramp at a heating rate of 2-5 °C/min, and maintaining the temperature for 2-4 hours; and after calcination, naturally cooling the treated working anode to room temperature, and taking out the electrode to obtain a piece of calcined titanium suboxide fibrofelt;
Step 3: placing the calcined titanium suboxide fibrofelt in step 2 and sodium hypophosphite monohydrate respectively in two porcelain boats, and then placing the two porcelain boats in the center of a tubular furnace, wherein the sodium hypophosphite monohydrate is placed upstream in the tubular furnace, and the distance between the calcined titanium suboxide fibrofelt and the sodium hypophosphite monohydrate is 2-6 cm; and after calcination in nitrogen atmosphere with a heating rate of 0.5-10 °C/min, a reaction temperature of 250-400 °C and a reaction time of 1-4 hours, naturally cooling the titanium suboxide fibrofelt to room temperature, taking out the treated titanium suboxide fibrofelt, placing the treated titanium suboxide fibrofelt in an electrochemical reduction reaction device as a cathode, using a lead oxide electrode as an anode, using a 20-200 mmol/L aqueous solution of ammonium sulfate as an electrolytic solution, and operating at a constant current density of 2-3 mA/cm² for 2-10 minutes to obtain a phosphorus-doped high-curvature regulated titanium suboxide porous electrode.

An application of the phosphorus-doped high-curvature regulated titanium suboxide porous electrode in electrochemically enhanced deep reduction of antibiotic resistance genes in pharmaceutical wastewater is provided.

An electrochemical oxidation system is constructed by using the phosphorus-doped high-curvature regulated titanium suboxide porous electrode as an anode and a Ti plate as a cathode; and under a constant current density of 1-20 mA/cm² and a reaction temperature of 24-26 °C, plasmids pUC57 carrying sulfonamide, tetracycline and cephalosporin antibiotic resistance genes (ARGs) are respectively used as target ARGs, the concentration of the ARGs added is 50 ng/L, the reaction time is 10 minutes, and the removal rates for all the three ARGs can reach over 90%;

An electrochemical oxidation system is constructed by using the phosphorus-doped high-curvature regulated titanium suboxide porous electrode as an anode and a Ti plate as a cathode; and under a constant current density of 1-10 mA/cm² and a reaction temperature of 24-26 °C, the antibiotics of sulfamethoxazole, tetracycline and cefixime with a concentration of 1 μg/L-1000 μg/L are used as target pollutants, the reaction time is 5 minutes, and the removal rates for all the pollutants can reach over 95%;

An electrochemical oxidation system is constructed by using the phosphorus-doped high-curvature regulated titanium suboxide porous electrode as an anode and a Ti plate as a cathode; and under a constant current density of 10 mA/cm² and a reaction temperature of 24-26 °C, effluents from biological treatment units of pharmaceutical wastewater containing sulfonamides, tetracyclines and cephalosporins are respectively used as target water bodies (with an actual wastewater COD of 150-250 mg/L), the reaction time is 30 minutes, the removal rates for all the three ARGs can reach over 90%, and the removal rate for COD can reach over 80%.

The present invention has the following beneficial effects: in the method of the present invention, ammonium fluoride electrochemical etching and in-situ phosphorus doping are conducted to synergistically regulate the surface curvature and lattice structure of a porous titanium suboxide electrode material, increase the average current density of an electro-oxidation system, and simultaneously enhance the ⋅OH generation rate, thus to achieve efficient and low-consumption degradation of antibiotic resistance genes and antibiotics in pharmaceutical wastewater. Through the ammonium fluoride electrochemical etching in step 1 and step 2, a high-curvature nanostructure is constructed on the surface of the material, effectively expanding the specific surface area of electrochemical activity. The tip electric field enhancement effect thereof induces the formation of a local strong electric field and charge aggregation phenomenon in a high-curvature region, increasing the local charge density at an active reaction site in an electrochemical reaction process, thereby enhancing the electrical conductivity of the system. Through in-situ phosphorus doping in step 3, the redox reaction of PH₃ on the surface of titanium suboxide is utilized to further increase the surface curvature of the material. Combined with the synergistic effect of P-doping into the lattices of titanium suboxide, the tensile strain effect of a local structure is triggered, which increases the lattice spacing, reduces the overlap degree of Ti orbitals, narrows the d-band, and migrates the center of the d-band upwards, thereby reducing the reaction energy barrier for converting water molecules into ⋅OH and enhancing the ⋅OH generation rate. In addition, local electron configuration at a P site can also be regulated by the tensile effect of strain, forming an effective electron migration channel, which can enhance the adsorption capacity of the P site for oxygen molecules and reduce the energy barrier for the conversion of oxygen molecules into singlet oxygen (¹O₂). The tip electric field enhancement effect induced by high curvature triggers the formation of a strong electric field distribution and a charge enrichment region at a nanocone tip on the surface of an electrode, promoting the rapid accumulation of electrons in electrochemical reaction and further increasing the ¹O₂ generation rate at a local P site. Therefore, the material can simultaneously achieve the efficient generation of ⋅OH and ¹O₂, thereby enhancing the efficient and deep removal of ARGs and antibiotics in actual water bodies by the system. In addition, the preparation method is simple and low-cost, and has a potential for industrial production.

### DESCRIPTION OF DRAWINGS

FIG. 1 shows SEM images of an electrode material, wherein (a) is an SEM image of a piece of pure titanium fibrofelt, and (b) is an SEM image of an FN2-4-P0.5 electrode material.

FIG. 2 shows EDS surface scan images of an FN2-4-P0.5 electrode material of P element.

FIG. 3 is a degradation diagram of SMX with different concentrations treated by an FN2-4-P0.5 electrode.

FIG. 4 is a schematic diagram of a reaction device for large-scale application of FN2-4-P0.5 electrodes.

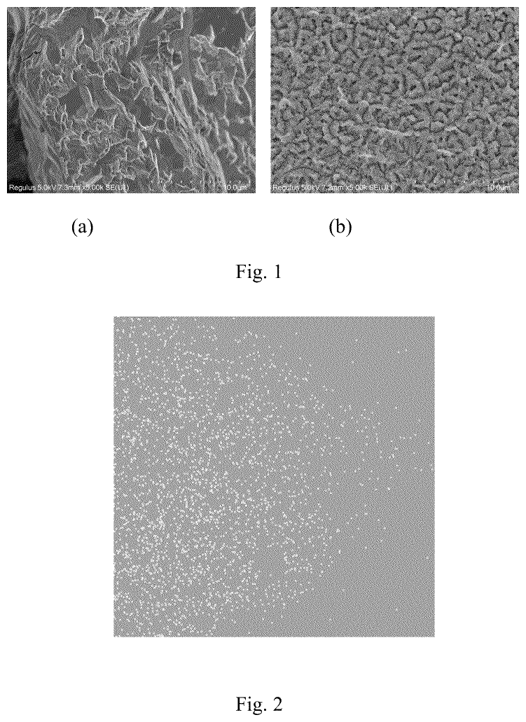

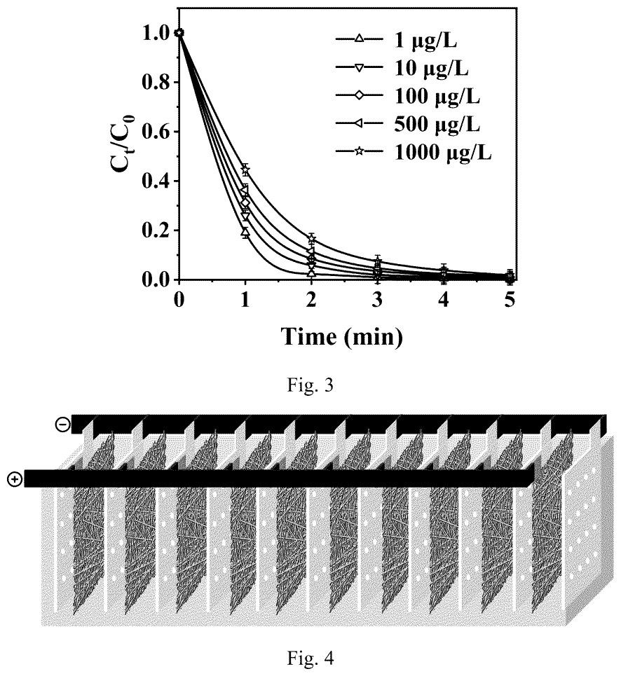

### DETAILED DESCRIPTION

Specific embodiments of the present invention are described below in detail in combination with the technical solution and the drawings.

### Embodiment 1

A preparation method for phosphorus-doped porous high-curvature titanium suboxide electrodes comprises:

Placing a piece of titanium suboxide fibrofelt (10×10 cm²) in a 10 wt. % sodium hydroxide solution and heating at 85 °C for 1 hour; after reaction, taking out the titanium suboxide fibrofelt and washing twice alternately with deionized water and ethanol. Then placing the titanium suboxide fibrofelt in a 15 wt. % oxalic acid solution and heating at 85 °C for 2 hours; and after reaction, taking out the titanium suboxide fibrofelt and washing twice alternately with deionized water and ethanol.

Mixing 25 mL of 0.1 g/mL ammonium fluoride solution thoroughly with 500 mL of ethylene glycol, using the titanium suboxide fibrofelt as an anode and Ti plates as dual cathodes, and conducting electrochemical etching for 4 hours under a voltage of 30 V and a current of 2 A; and after the reaction, washing twice alternately with deionized water and ethanol and blowing dry the moisture on the surface. Placing the electrodes in a muffle furnace; and after calcination with a heating rate of 2.5 °C/min, a reaction temperature of 450 °C and a reaction time of 2 hours, naturally cooling the electrodes to room temperature, and taking out the titanium suboxide electrode.

Putting 0.5 g of sodium hypophosphite monohydrate in a porcelain boat, placing the porcelain boat upstream of a tubular furnace, and placing the titanium suboxide electrode downstream of the tubular furnace. Conducting calcination with the tubular furnace under N₂ protection, with a heating rate of 3 °C/min, a reaction temperature of 350 °C and a reaction time of 2 hours. After reaction, cooling the electrode to room temperature, taking out the electrode, washing twice alternately with deionized water and ethanol, and reducing with a 1 M (NH₄)₂SO₄ solution for 2 minutes to obtain a phosphorus-doped porous high-curvature titanium suboxide electrode (FN2-4-P0.5).

Using the same preparation conditions as in embodiment 1, and changing only the dosage of P to 0 g, 0.1 g, 1 g, 2 g and 3 g respectively, with other conditions remaining unchanged, to prepare FN-P series electrodes. Electrode samples are respectively numbered as FN2-4-P0, FN2-4-P0.1, FN2-4-P1, FN2-4-P2 and FN2-4-P3, which are used for subsequent comparison tests of antibiotic and antibiotic resistance gene removal performance.

Using the same preparation conditions as in embodiment 1, and changing only the current for electrochemical etching to 1 A and 3 A respectively, with other conditions remaining unchanged, to prepare FN-P series electrodes. Electrode samples are respectively numbered as FN1-4-P0.5 and FN3-4-P0.5, which are used for subsequent comparison tests of antibiotic and antibiotic resistance gene removal performance.

Using the same preparation conditions as in embodiment 1, and changing only the time for electrochemical etching to 2 hours, 3 hours and 6 hours respectively, with other conditions remaining unchanged, to prepare FN-P series electrodes. Electrode samples are respectively numbered as FN2-1-P0.5, FN2-3-P0.5 and FN2-6-P0.5, which are used for subsequent comparison tests of antibiotic and antibiotic resistance gene removal performance.

### Application Example 1

Removal of ARGs by electrochemical oxidation: adding 100 mL simulated antibiotic resistance gene wastewater prepared by sulfonamide, tetracycline and cephalosporin ARGs (with a concentration of 50 ng/L) to an electrooxidation reactor, respectively. The concentration of Na₂SO₄ electrolyte is 10 mmol/L, an FN-P series electrode is used as an anode, Ti plates are used as cathodes, and the reaction time is 10 minutes. The DNA damage and removal of extracellular antibiotic resistance genes (eARGs) are detected by DNA gel electrophoresis and real-time polymerase chain reaction (qPCR). The removal rates for all the three target ARGs can reach over 70% within 10 minutes of reaction. 90% of the ARGs in the solution can be removed by FN2-4-P0.5, FN2-4-P1, FN2-4-P2, FN2-4-P3, FN2-3-P0.5, FN2-6-P0.5, FN1-4-P0.5 and FN3-4-P0.5 after 10 minutes of reaction. Only 40% of the three target ARGs can be removed by FN2-4-P0 without P-doping. More than 95% of the target ARGs can be removed by FN2-4-P0.5 after 5 minutes of reaction. This indicates that an overly long electrochemical etching time and an excessively high P dosage will affect the ability of the FN-P electrodes to remove ARGs, which is because the structural stability of the surface active sites of the FN-P material is decreased under such preparation conditions, thereby inhibiting the ¹O₂ generation rate. Compared with FN2-4-P0, P-doped regulated lattice tensile strain induces lattice expansion, making the performance of the FN-P electrodes in removing ARGs superior to that of the FN2-4-P0 electrodes.

### Application Example 2

Method for electrocatalytic degradation of typical antibiotics: weighing 0.426 g of Na₂SO₄ electrolyte and adding the Na₂SO₄ electrolyte respectively to an electrocatalytic reactor containing 100 mL of sulfamethoxazole, tetracycline and cefixime (5 mg/L). Using an FN-P series electrode as an anode, and using Ti plates as cathodes, with the current density being 5 mA/cm², and the reaction time being 5 minutes. Taking the reaction solution once every 1 minute, filtering the taken reaction solution through a 0.22 μm filter membrane, taking 1 mL of the filtered reaction solution, and testing the filtered reaction solution with an instrument to obtain the degradation rate.

Determining the concentration of SMX by ultra-performance liquid chromatography, and calculating the removal rate based on the concentration change before and after reaction. The test results show that after 5 minutes of reaction, the FN-P series electrode has a removal rate of >80% for sulfamethoxazole, tetracycline and cefixime. Among which, FN2-4-P0.5 can achieve a removal rate of 95% for the above three antibiotics within 4 minutes of reaction; After 30 minutes of reaction, the TOC removal rates are 80%, 78% and 68%, respectively. This indicates that the FN-P series electrode has a high degradation and mineralization performance for typical antibiotic pollutants in pharmaceutical wastewater.

### Application Example 3

Test on electrocatalytic degradation of sulfamethoxazole, tetracycline and cefixime with different concentrations: adding sulfamethoxazole, tetracycline and cefixime with different concentrations (1 μg/L, 100 μg/L and 1000 μg/L) to an electrocatalytic reactor containing 100 mL of antibiotic wastewater with different concentrations together with 0.426 g of Na₂SO₄ electrolyte, respectively. Using FN2-4-P0.5 as an anode, and using Ti plates as cathodes, with the current density being 5 mA/cm², and the reaction time being 5 minutes. Taking the reaction solution once every 1 minute, filtering the taken reaction solution through a 0.22 μm filter membrane, taking 1 mL of the filtered reaction solution, and testing the filtered reaction solution with an instrument to obtain the degradation rate.

Determining the concentration of SMX by ultra-performance liquid chromatography, and calculating the removal rate based on the concentration change before and after reaction. The test results show that FN2-4-P0.5 has a removal rate of over 99% for sulfamethoxazole, tetracycline and cefixime. The TOC removal rates for sulfamethoxazole, tetracycline and cefixime with different concentrations are >85%, 82% and 75%, respectively. This indicates that FN2-4-P0.5 has a high degradation and mineralization performance for typical antibiotic pollutants with different concentrations in pharmaceutical wastewater.

### Application Example 4

### Test on Electrocatalytic Degradation of Actual Pharmaceutical Wastewater

Using FN2-4-P0.5 as an anode, and using Ti plates as cathodes, with the current density being 5 mA/cm². Using effluents from biological units of actual pharmaceutical wastewater (containing sulfamethoxazole, tetracycline and cefixime respectively) (with a COD content of 150-250 mg/L) as target water bodies to conduct antibiotic and ARG removal tests, with the reaction time being 30 minutes. Taking the reaction effluents once every 10 minutes, filling the taken reaction effluents into 10 mL centrifuge tubes, and uniformly collecting the centrifuge tubes for COD removal performance testing. In addition, investigating the content of ARGs in the wastewater before and after reaction.

Testing the COD of the effluents by a national standard method. The test results show that the FN2-4-P0.5 electrode has a removal rate of 83%, 80% and 81% for the COD of the actual pharmaceutical wastewater, respectively. This indicates that the anode has a high removal performance for typical antibiotics in the actual pharmaceutical wastewater. The test results of content of ARGs in the wastewater before and after reaction show that the FN2-4-P0.5 anode has a removal rate of 90% for ARGs in the wastewater, which can effectively reduce the potential harm to the ecological environment caused by the discharge of the wastewater into natural water bodies.

### Application Example 5

### Detection of Active Species in Electrocatalytic Degradation of Sulfamethoxazole

Adding 0.38 mL of isopropyl alcohol and 0.434 mL of furfuryl alcohol to an electrocatalytic reactor containing 100 mL of sulfamethoxazole (5 mg/L) together with 0.426 g of Na₂SO₄ electrolyte, respectively. Using an FN2-4-P0.5 electrode as an anode, and using Ti plates as cathodes, with the current density being 5 mA/cm², and the reaction time being 5 minutes. Taking the reaction solution once every 1 minute, filtering the taken reaction solution through a 0.22 μm filter membrane, taking 1 mL of the filtered reaction solution, and testing the filtered reaction solution with an instrument to obtain the degradation rate.

Determining the concentration of SMX by ultra-performance liquid chromatography, and comparing the degradation rate of SMX with that in application example 2. The test results show that after the addition of isopropyl alcohol, the degradation rate of sulfamethoxazole by the FN2-4-P0.5 anode is reduced by 45.8%; and after the addition of furfuryl alcohol, the degradation rate of sulfamethoxazole by the FN2-4-P0.5 anode is reduced by 40.6%. This indicates that ⋅OH and ¹O₂ play a major role in the degradation of sulfamethoxazole by the FN2-4-P0.5 anode.

### Application Example 6

### ^{⋅}OH Generation Rate Test

Weighing 0.426 g of Na₂SO₄ electrolyte and adding the Na₂SO₄ electrolyte to an electrocatalytic reactor containing 100 mL of coumarin (1 mmol/L). Using an FN2-4-P0 electrode and an FN2-4-P0.5 electrode as an anode respectively, and using Ti plates as cathodes, with the current density being 5 mA/cm², and the reaction time being 5 minutes. Taking the reaction solution once every 1 minute, filtering the taken reaction solution through a 0.22 μm filter membrane, taking 1 mL of the filtered reaction solution, and testing the filtered reaction solution with an instrument to obtain the ⋅OH generation rate.

Determining the concentration of 7-hydroxycoumarin, a product of selective reaction between ⋅OH and coumarin, by ultra-performance liquid chromatography to indirectly test the ⋅OH generation rate. The test results show that after 5 minutes of reaction, the ⋅OH generation rate of the FN2-4-P0.5 anode is 7.83×10⁻⁷ M/(cm²·min), which is 5.4 times the ⋅OH generation rate of the FN2-4-P0 anode (1.44×10⁻⁷ M/(cm²·min)). This indicates that the increase in the proportion of Ti³⁺ and in the concentration of oxygen vacancies after phosphorus doping promotes the stable and continuous generation of ⋅OH.

### Application Example 7

### ¹O₂ Generation Rate Test

Weighing 0.426 g of Na₂SO₄ electrolyte and adding the Na₂SO₄ electrolyte to an electrocatalytic reactor containing 100 mL of 9,10-dimethylanthracene (10 mM) prepared by dissolving in an organic solvent with a volume ratio to water of 1:1(V/V). Using an FN2-4-P0 electrode and an FN2-4-P0.5 electrode as an anode respectively, and using Ti plates as cathodes, with the current density being 5 mA/cm², and the reaction time being 5 minutes. Taking the reaction solution once every 1 minute, filtering the taken reaction solution through a 0.22 μm filter membrane, taking 1 mL of the filtered reaction solution, and testing the filtered reaction solution with an instrument to obtain the ¹O₂ generation rate.

Determining the concentration of 9,10-dimethylanthracene by ultra-performance liquid chromatography to indirectly test the ¹O₂ generation rate. The test results show that after 5 minutes of reaction, the ¹O₂ generation rate of the FN2-4-P0.5 anode is 8.05×10⁻⁷ M/(cm²·min), which is 3.7 times the ¹O₂ generation rate of the FN2-4-P0 anode (2.16×10⁻⁷ M/(cm²·min)). This indicates that the tensile effect of strain enhances oxygen adsorption and reduces the conversion energy barrier by regulating the electron configuration at a P site. At the same time, the tip electric field effect induced by high curvature promotes charge enrichment and electron accumulation, thereby accelerating the ¹O₂ generation rate.

### Application Example 8

### Test on Influence of Ions and Natural Organic Matters on Performance of Electrocatalytic Degradation of Sulfamethoxazole

Adding cations (i.e., potassium ions (K₂SO₄), calcium ion (Ca(NO₃)₂) and magnesium ions (Mg(NO₃)₂)), anions (i.e., nitrate ions (KNO₃) and chloride ions (NaCl)), and a natural organic matter (humic acid) to an electrocatalytic reactor containing 100 mL of sulfamethoxazole (5 mg/L) together with 0.426 g of Na₂SO₄ electrolyte respectively, with the concentration of each kind of ions being 1 mmol/L, and the concentration of the humic acid being 10 mg/L. Using an FN2-4-P0.5 electrode as an anode, and using Ti plates as cathodes, with the current density being 5 mA/cm², and the reaction time being 5 minutes. Taking the reaction solution once every 1 minute, filtering the taken reaction solution through a 0.22 μm filter membrane, taking 1 mL of the filtered reaction solution, and testing the filtered reaction solution with an instrument to obtain the degradation rate.

Determining the concentration of SMX by ultra-performance liquid chromatography, and comparing the degradation rate of SMX with that in application example 2. The test results show that after the addition of the potassium ions, the degradation efficiency of SMX does not change significantly. The degradation of SMX can be promoted by the calcium ions, the magnesium ions, the nitrate ions and carbonate ions; the electrical double layer can be compressed by the calcium ions and the magnesium ions to promote the diffusion of pollutants to the interface; the active nitrogen species such as NO₃⋅ and NO₂⋅ generated by NO₃⁻ have selectivity for SMX; and the carbonate ions can be adsorbed by the P site to promote electron transfer to Ti⁴⁺. The degradation of SMX can be inhibited by the chloride ions and the natural organic matter; ⋅OH can be quenched by the chloride ions to reduce the steady-state concentration thereof; and the natural organic matter and SMX will undergo competing reactions in a degradation process.

### Application Example 9

### Large-Scale Application of FN2-4-P0.5 Electrodes

Using the same preparation conditions as in embodiment 1, and amplifying the FN2-4-P0.5 electrode to 25 cm×25 cm. An electrochemical oxidation device adopts a single-pole parallel plate electrode structure, which includes a total of 11 cathodes and 10 anodes, the electrodes are arranged in a cathode-anode alternate mode in sequence, the electrode spacing is 1.5 cm, and the electrodes at both ends are cathodes. The effective area of each of the anodes and the cathodes is 25 cm×25 cm. The effective volume of the reactor is 100 L. The reactor is designed as a flow-through type. Pharmaceutical wastewater first flows through a cathode area and then successively passes through the gaps among the alternately arranged anodes and cathodes to achieve the electrochemical oxidation and degradation of antibiotic resistance genes and antibiotic pollutants on the surface of each anode.

Using FN2-4-P0.5 as an anode, and using Ti plates as cathodes, with the current density being 5 mA/cm². Taking influent to a biological treatment unit of a pharmaceutical factory as a treatment object. The influent contains cephalosporin antibiotics and sulfonamide antibiotics. The concentration of the cephalosporin antibiotics is 14.3-39.1 mg/L, and the concentration of the sulfonamide antibiotics is 22.1-57.7 mg/L. The electrochemical pretreatment process described in the present invention is adopted to conduct electrochemical pretreatment on the influent of the biological treatment unit of the above-mentioned wastewater, the treatment capacity of the device is 400 L/h, and the hydraulic detention time of an electrochemical reaction section is 15 minutes. After electrochemical pretreatment, the removal rate for sulfonamide antibiotics in effluent reaches over 90%. Subsequently, the effluent after electrochemical pretreatment enters an activated carbon filtration unit, with an activated carbon filtration contact time of 2 minutes, to remove residual oxidizing species in the water body, and then enters a subsequent biological treatment unit.

Taking the wastewater that directly enters the biological treatment unit without electrochemical pretreatment as a control. The results show that after being treated by the combined process of “electrochemical pretreatment—activated carbon filtration unit—biological treatment unit”, the total removal rates for cephalosporin antibiotics and sulfonamide antibiotics in the effluent reach >99.9% and >99.7%, respectively; and when the effluent directly enters the biological treatment unit without electrochemical pretreatment, the total removal rates for cephalosporin antibiotics and sulfonamide antibiotics are >79.1% and >64.9%, respectively. In the condition that the COD of the effluent is less than 100 mg/L, the hydraulic detention time required by the biological treatment unit with the influent treated by electrochemical pretreatment is only 70%-80% of that required by the biological treatment unit with the influent not treated by electrochemical pretreatment.

In addition, compared with the effluent of the biological treatment unit without electrochemical pretreatment, the abundances of typical cephalosporin antibiotic resistance related genes and typical sulfonamide antibiotic resistance genes in the effluent of the biological treatment unit with the influent treated by electrochemical pretreatment are significantly reduced. Among which, the total abundance of typical cephalosporin antibiotic resistance related genes CepA-44 and ADC-127 is reduced from 9.77-14.63 RPKM to 0.11-0.16 RPKM; the total abundance of typical sulfonamide antibiotic resistance genes sul1 and sul2 reduced from 18.04-23.19 RPKM to 0.34-0.61 RPKM.

The above results indicate that the electrochemical pretreatment process described in the present invention can effectively reduce the antibiotic load in the influent of the biological treatment unit, lower the risk of release of residual antibiotics and antibiotic resistance genes after entering a subsequent biological treatment system, and shorten the hydraulic detention time of the subsequent biological treatment unit in the condition of achieving the same COD effluent level.

### Application Example 10

### Test on Stability of FN2-4-P0.5 Electrodes

Using an FN2-4-P0.5 electrode as an anode, using Ti plates as cathodes, and controlling the current density to be 5 mA/cm². Adopting the same electrochemical pretreatment process as in application example 9, and taking effluent from a secondary sedimentation tank of a biological treatment process for actual pharmaceutical wastewater without electrochemical pretreatment as a treatment object. The COD content of the effluent from the secondary sedimentation tank is 110-200 mg/L, the concentration of cephalosporin antibiotics is 3.36-9.28 mg/L, the concentration of sulfonamide antibiotics is 12.47-20.09 mg/L, and the abundance of typical ARGs is approximately 20 RPKM. Conducting a continuous 7-day test on the removal stability for antibiotics and antibiotic resistance genes. During the test, operating the electrochemical pretreatment process continuously, and taking the reaction effluent once every 4 hours. Directly filling the water samples taken into 10 mL centrifuge tubes, and uniformly collecting the centrifuge tubes for the detection and analysis of COD, cephalosporin antibiotics, sulfonamide antibiotics and typical antibiotic resistance genes.

The test results show that during the continuous 7-day operation, the removal rate for COD of the reaction effluent remains over 80%. At the same time, the removal rates for cephalosporin antibiotics and sulfonamide antibiotics remain over 99%. The detection results of typical antibiotic resistance genes indicate that after electrochemical treatment by the FN2-4-P0.5 anode, the abundances of typical cephalosporin antibiotic resistance related genes and typical sulfonamide antibiotic resistance genes in the effluent are significantly reduced.

In addition, during continuous operation, the cell voltage of the electrochemical pretreatment process remains stable within the range of 5-6 V, without any significant increase. The above results indicate that the FN2-4-P0.5 anode has good operational stability during deep treatment of actual pharmaceutical wastewater and can stably remove COD, cephalosporin antibiotics, sulfonamide antibiotics and typical antibiotic resistance genes from the wastewater.

1. A preparation method for phosphorus-doped high-curvature regulated titanium suboxide porous electrodes, comprising the following steps:
step 1: pretreating a piece of titanium suboxide fibrofelt;
step 2: using the treated titanium suboxide fibrofelt obtained in step 1 as a working anode and using two titanium mesh electrodes as dual cathodes to construct a dual-cathode and single-anode electrochemical etching system; conducting electrochemical etching for 3-6 hours under a voltage of 20-30 V and a current of 2-3 A, and after etching, thoroughly rinsing the surface with deionized water and blowing dry the moisture on the surface; transferring the treated working anode to a muffle furnace, raising the temperature to 300-500 °C, and maintaining the temperature for 2-4 hours; and after calcination, naturally cooling the treated working anode to room temperature, and taking out the electrode to obtain a piece of calcined titanium suboxide fibrofelt;
step 3: placing the calcined titanium suboxide fibrofelt in step 2 and sodium hypophosphite monohydrate respectively in two porcelain boats, and then placing the two porcelain boats in the center of a tubular furnace; and after calcination in nitrogen atmosphere with a reaction temperature of 250-400 °C and a reaction time of 1-4 hours, naturally cooling the titanium suboxide fibrofelt to room temperature, taking out the treated titanium suboxide fibrofelt, placing the treated titanium suboxide fibrofelt in an electrochemical reduction reaction device as a cathode, using a lead oxide electrode as an anode, using a 20-200 mmol/L aqueous solution of ammonium sulfate as an electrolytic solution, and operating at a constant current density of 2-3 mA/cm² for 2-10 minutes to obtain a phosphorus-doped high-curvature regulated titanium suboxide porous electrode.

2. The preparation method for phosphorus-doped high-curvature regulated titanium suboxide porous electrodes according to claim 1, wherein the specific steps of pretreating a piece of titanium suboxide fibrofelt in step 1 are as follows:
immersing a piece of titanium suboxide fibrofelt in a sodium hydroxide solution with a concentration of 5-10 wt. %, and conducting treatment at a constant temperature of 70-85 °C for 0.5-1 hour; taking out the titanium suboxide fibrofelt, and conducting ultrasonic cleaning with deionized water to remove residual alkaline solution on the surface; subsequently, transferring the treated titanium suboxide fibrofelt to an oxalic acid solution of 10-15 wt. %, and continuing to conduct treatment at a constant temperature of 70-85 °C for 1-3 hours; and taking out the titanium suboxide fibrofelt, and thoroughly removing acidic residue on the surface with deionized water to obtain the treated titanium suboxide fibrofelt.

3. The preparation method for phosphorus-doped high-curvature regulated titanium suboxide porous electrodes according to claim 1, wherein the electrolytic solution of the dual-cathode and single-anode electrochemical etching system in step 2 is prepared by uniformly mixing a 0.1 g/mL ammonium fluoride solution with ethylene glycol, in which the volume ratio of the 0.1 g/mL ammonium fluoride solution to the ethylene glycol is 1:20 to 1:10.

4. The preparation method for phosphorus-doped high-curvature regulated titanium suboxide porous electrodes according to claim 1, wherein the sodium hypophosphite monohydrate in step 3 is placed upstream in the tubular furnace, and the distance between the calcined titanium suboxide fibrofelt and the sodium hypophosphite monohydrate is 2-6 cm.

5. An application of the phosphorus-doped high-curvature regulated titanium suboxide porous electrode according to claim 1 in electrochemically enhanced deep reduction of antibiotic resistance genes in pharmaceutical wastewater, wherein
an electrochemical oxidation system is constructed by using the phosphorus-doped high-curvature regulated titanium suboxide porous electrode as an anode and a Ti plate as a cathode; and under a constant current density of 1-20 mA/cm² and a reaction temperature of 24-26°C, plasmids pUC57 carrying sulfonamide, tetracycline and cephalosporin antibiotic resistance genes are respectively used as target ARGs, the concentration of the ARGs added is 50 ng/L, the reaction time is 10 minutes, and the removal rates for all the three ARGs can reach over 90%;
an electrochemical oxidation system is constructed by using the phosphorus-doped high-curvature regulated titanium suboxide porous electrode as an anode and a Ti plate as a cathode; and under a constant current density of 1-10 mA/cm² and a reaction temperature of 24-26 °C, the antibiotics of sulfamethoxazole, tetracycline and cefixime with a concentration of 1 μg/L-1000 μg/L are used as target pollutants, the reaction time is 5 minutes, and the removal rates for all the pollutants can reach over 95%;
an electrochemical oxidation system is constructed by using the phosphorus-doped high-curvature regulated titanium suboxide porous electrode as an anode and a Ti plate as a cathode; and under a constant current density of 10 mA/cm² and a reaction temperature of 24-26 °C, effluents from biological treatment units of pharmaceutical wastewater containing sulfonamides, tetracyclines and cephalosporins are respectively used as target water bodies, the COD of the target water bodies is 150-250 mg/L, the reaction time is 30 minutes, the removal rates for all the three ARGs can reach over 90%, and the removal rate for COD can reach over 80%.
